(19) United States
(12) Patent Application Publication
(10) Pub. No.: US 2014/0002662 A1
(43) Pub. Date: Jan. 2, 2014

(54) PARTICLE CHARACTERIZATION

(71) Applicants: E. Neil Lewis, Brookeville, MD (US); John McCaffrey, Columbia, MD (US); Kenneth S. Haber, Frederick, MD (US); Peter Bennett, Columbia, MD (US); Gerald Sando, Savage, MD (US); Tomasz Sadowski, Warsaw (PL)

(72) Inventors: E. Neil Lewis, Brookeville, MD (US); John McCaffrey, Columbia, MD (US); Kenneth S. Haber, Frederick, MD (US); Peter Bennett, Columbia, MD (US); Gerald Sando, Savage, MD (US); Tomasz Sadowski, Warsaw (PL)

(21) Appl. No.: 13/841,721

(22) Filed: Mar. 15, 2013

Related U.S. Application Data
(60) Provisional application No. 61/679,662, filed on Aug. 3, 2012.
(60) Provisional application No. 61/663,527, filed on Jun. 22, 2012.

(51) Int. Cl. G01N 15/06

(52) U.S. Cl. CPC G01N 15/0612
USPC 348/159

(57) ABSTRACT

In one general aspect, a particle characterization method is disclosed that includes suspending particles in a fluid, causing them to flow past a two-dimensional array detector, and illuminating them as they do so. The method also includes acquiring images of the particles as they flow past the two-dimensional array detector in the fluid, and applying a particle characterization function to the images for at least some of the suspended particles.

### CROSS-REFERENCE TO RELATED APPLICATION

This application claims the benefit of U.S. provisional application Nos. 61/663,527 filed on Jun. 22, 2012 and 61/679,662 filed on Aug. 3, 2012, which are herein incorporated by reference.

### FIELD OF THE INVENTION

This invention relates to methods and apparatus for detecting properties of particles, including detecting properties of particles in industrial processes.

### BACKGROUND OF THE INVENTION

Lensless microfluidic detection techniques have been proposed to acquire microscopic images of samples such as biological materials and cells. They operate by acquiring images of suspended samples in close proximity to a high-resolution imaging detector. Their small size has resulted in their use being proposed in a variety of life science applications, including microscopes, smart petri dishes, and point-of-care diagnostic systems.

### SUMMARY OF THE INVENTION

In one general aspect, the invention features a particle characterization method that includes suspending particles in a fluid, causing them to flow past a two-dimensional array detector, and illuminating them as they do so. The method also includes acquiring images of the particles as they flow past the two-dimensional array detector in the fluid, and applying a particle characterization function to the images for at least some of the suspended particles.

a particle characterization method that includes suspending particles in a fluid, causing the suspended particles to flow past a two-dimensional array detector, and illuminating them as they do so. The method also includes acquiring a plurality of images of the particles as they flow past the two-dimensional array detector in the fluid, and applying a particle characterization function to results of steps of acquiring a plurality of images for at least some of the suspended particles.

In preferred embodiments the step of applying a particle characterization function can categorize the particles according to at least one morphological characteristic. The step of applying a particle characterization function can categorize the particles according to their shapes. The step of applying a particle characterization function can categorize the particles according to their sizes. The step of applying a particle characterization function can categorize the particles statistically. The step of illuminating can include a step of strobing a source for a plurality of short acquisition periods with the step of acquiring acquiring the images during the plurality of short acquisition periods. The method can further include the step of displaying the images of the particles in a sorted thumbnail view. The steps of suspending, causing, acquiring, and applying can be carried out as part of a molecular microbiological method. The steps of suspending, causing, acquiring, and applying can be part of a manufacturing process quality assurance cycle. The steps of suspending, causing, acquiring, and applying can be part of a manufacturing process quality control evaluation. The steps of suspending, causing, acquiring, and applying can be applied to evaluate a dispersion step. The steps of suspending, causing, acquiring, and applying can be applied to pharmaceutical composition particles. The steps of suspending, causing, acquiring, and applying can be applied to pharmaceutical composition particles. The step of applying a particle characterization function can apply a contaminant detection function. The step of applying a particle characterization function can apply a counterfeit detection function. The method can further include the step of performing an additional particle characterization operation while the particles are suspended in the same fluid. The further particle characterization operation can include a laser diffraction step. The further particle characterization operation can take place in parallel with the steps of causing, acquiring, and applying. The further particle characterization operation can take place in series with the steps of causing, acquiring, and applying. The method can further include the step of extracting images of individual particles from image data received in the step of acquiring and transferring these extracted images through a communication channel to a user computer. The step of causing the suspended particles to flow past a two-dimensional array detector can cause them to flow along a single flow path that has a profile that includes a detector flow region and a pair of bypass channels. The step of causing the suspended particles to flow past a two-dimensional array detector can cause them to flow along a path with substantially no zero-flow regions. The step of causing the suspended particles to flow past a two-dimensional array detector can cause them to flow at a flow rate of at least one liter per minute. The method can further include the step of applying a statistical function to image data from the two-dimensional array detector to gage heterogeneity. The fluid can be a liquid.

In another general aspect, the invention features a particle characterization instrument that includes a two-dimensional detector, channel walls mounted to the detector for defining a channel to hold a fluid containing a sample in contact with the two-dimensional detector, a driver to move the fluid through the channel, an imaging illumination source positioned to illuminate particles in the fluid while it is in contact with the two-dimensional detector, and a coherent scattering illumination source positioned to illuminate particles in the fluid.

In preferred embodiments The coherent scattering illumination source can be positioned to interact with the fluid while it is in contact with the two-dimensional detector with the two-dimensional detector being positioned to both detect light from particles illuminated by the imaging illumination detector and to detect light scattered by particles in the fluid illuminated by the coherent scattering illumination source. The instrument can further including a scattering detector positioned to receive light scattered by particles in the fluid illuminated by the coherent scattering illumination source.

In a further general aspect, the invention features a particle characterization method that includes suspending particles in a fluid, causing the suspended particles to flow past a two-dimensional array detector, and acquiring a plurality of calibration images of the particles as they flow past the two-dimensional array detector in the fluid, illuminating the suspended particles as they flow past the two-dimensional array detector in the fluid, acquiring a plurality of sample images of the particles as they flow past the two-dimensional array detector in the fluid, and correcting the sample images of the particles using the calibration images.

In preferred embodiments the step of correcting can perform a flat-field correction. The step of acquiring a plurality of calibration images of the particles can acquire illuminated images and dark images. The method can further include the step of averaging the acquired calibration images to reduce the effect of the suspended particles in a result of the step of averaging. The method can further include the step of discarding pixels exceeding a predetermined threshold in the calibration images before the step of averaging.

In another general aspect, the invention features a particle characterization instrument that includes means for causing the suspended particles to flow past a two-dimensional array detector, means for illuminating the suspended particles as they flow past the two-dimensional array detector in the fluid, means for acquiring a plurality of images of the particles as they flow past the two-dimensional array detector in the fluid, and means for applying a particle characterization function to results from the means for acquiring for at least some of the suspended particles.

In a further general aspect, the invention features a particle characterization method that includes suspending particles in a fluid, causing a first subset of the suspended particles to flow past a first two-dimensional array detector, illuminating the first subset of suspended particles as they flow past the first two-dimensional array detector in the fluid, acquiring a plurality of images of the first subset of particles as they flow past the first two-dimensional array detector in the fluid, causing a second subset of the suspended particles to flow past a second two-dimensional array detector, illuminating the second subset of suspended particles as they flow past the second two-dimensional array detector in the fluid, and acquiring a plurality of images of the second subset of particles as they flow past the second two-dimensional array detector in the fluid.

In preferred embodiments, the step of causing a first subset of the suspended particles to flow past the first two-dimensional array detector and the step of causing a second subset of the suspended particles to flow past the second two-dimensional array detector can be performed in series. The step of causing a first subset of the suspended particles to flow past the first two-dimensional array detector and the step of causing a second subset of the suspended particles to flow past the second two-dimensional array detector can be performed in parallel. The method can further include the step of combining information from the images from the first and second two-dimensional array detectors. The step of causing a first subset of the suspended particles to flow past the first two-dimensional array detector and the step of causing a second subset of the suspended particles to flow past the second two-dimensional array detector can together cause the average size of particles that flow over the second array to be larger than the average size of particles that flow over the first array. The step of causing a first subset of the suspended particles to flow past the first two-dimensional array detector can cause the first subset of particles to flow through a first channel that has a first depth in front of the first detector, and the step of causing a second subset of the suspended particles to flow past the second two-dimensional array detector can cause the second subset of particles to flow through a second channel that has a second depth in front of the second detector, and wherein the first depth is deeper than the second depth. The step of causing a first subset of the suspended particles to flow past the first two-dimensional array detector can cause the first subset of particles to flow through a first compound channel that includes an imaging subchannel and one or more bypass subchannels that are larger than the imaging channel, with the step of causing a second subset of the suspended particles to flow past the second two-dimensional array detector causing the second subset of particles to flow through a second compound channel that includes an imaging subchannel and one or more bypass subchannels that are larger than the imaging channel. The step of causing a first subset of the suspended particles to flow past the first two-dimensional array detector can cause the first subset of particles to flow through a first compound channel that includes an imaging subchannel and one or more bypass subchannels that are larger than the imaging channel, with the step of causing a second subset of the suspended particles to flow past the second two-dimensional array detector causing the second subset of particles to flow through a second compound channel that includes an imaging subchannel and one or more bypass subchannels that are larger than the imaging channel. The method can further include the step of causing one or more further subsets of the suspended particles to flow past one or more further two-dimensional array detectors, illuminating the further subsets of suspended particles as they flow past the further two-dimensional array detectors in the fluid, and acquiring a plurality of images of the further subsets of particles as they flow past the further two-dimensional array detectors in the fluid.

In another general aspect, the invention features a particle characterization instrument that includes a first two dimensional detector, a second two-dimensional detector, channel walls mounted to the first and second two-dimensional detectors for defining a first channel to hold a fluid containing a sample in contact with the first two-dimensional detector and defining a second channel to hold the fluid containing a sample in contact with the second two-dimensional detector, wherein the first channel and the second channel are hydraulically connected and have a different cross-section, a driver to move the fluid through the channels, and an imaging illumination source positioned to illuminate particles in the fluid while it is in contact with the two-dimensional detector. In preferred embodiments the channel walls can define serial channels.

In a further general aspect, the invention features a particle characterization instrument that includes means for causing a first subset of the suspended particles to flow past a first two-dimensional array detector, means for illuminating the first subset of suspended particles as they flow past the first two-dimensional array detector in the fluid, means for acquiring a plurality of images of the first subset of particles as they flow past the first two-dimensional array detector in the fluid, means for using a second subset of the suspended particles to flow past a second two-dimensional array detector, means for illuminating the second subset of suspended particles as they flow past the second two-dimensional array detector in the fluid, and means for acquiring a plurality of images of the second subset of particles as they flow past the second two-dimensional array detector in the fluid.

Systems according to the invention can help to characterize a variety of different particulate materials in industrial settings, such as in the manufacture of pharmaceuticals. This can help to provide ongoing quality control and quality assurance in the manufacture of such materials.

### BRIEF DESCRIPTION OF THE DRAWING

FIG. 1 is a block diagram of a particle characterization system according to the invention,

FIG. 2A is a diagrammatic side-view sketch of a microfluidic cell block for use with the particle characterization system of FIG. 1,

FIG. 2B is a diagrammatic end-view sketch of the microfluidic cell block of FIG. 2A;

FIG. 2C is a diagrammatic top-view sketch of the microfluidic cell block of FIG. 2A;

FIG. 3 is an enlarged, partial cross-section of the microfluidic cell block of FIG. 2 that cuts through its window bolt perpendicularly to the direction of flow;

FIG. 4 is an image acquired using the microfluidic cell block of FIG. 2 in the particle characterization system of FIG. 1;

FIG. 5 is a sorted thumbnail view of particles in an image such as the one shown in FIG. 4,

FIG. 6 is an illustrative wet dispersion unit schematic for use with the particle characterization system of FIG. 1,

FIG. 7 is a flowchart illustrating the acquisition and processing of flat-field corrected frames for the particle characterization system of FIG. 1,

FIG. 8 is a side-view block diagram of a three-channel serial multichannel particle characterization system according to the invention, and

FIG. 9 is a top-view block diagram of a two-channel parallel multichannel particle characterization system according to the invention.

### DETAILED DESCRIPTION OF AN ILLUSTRATIVE EMBODIMENT

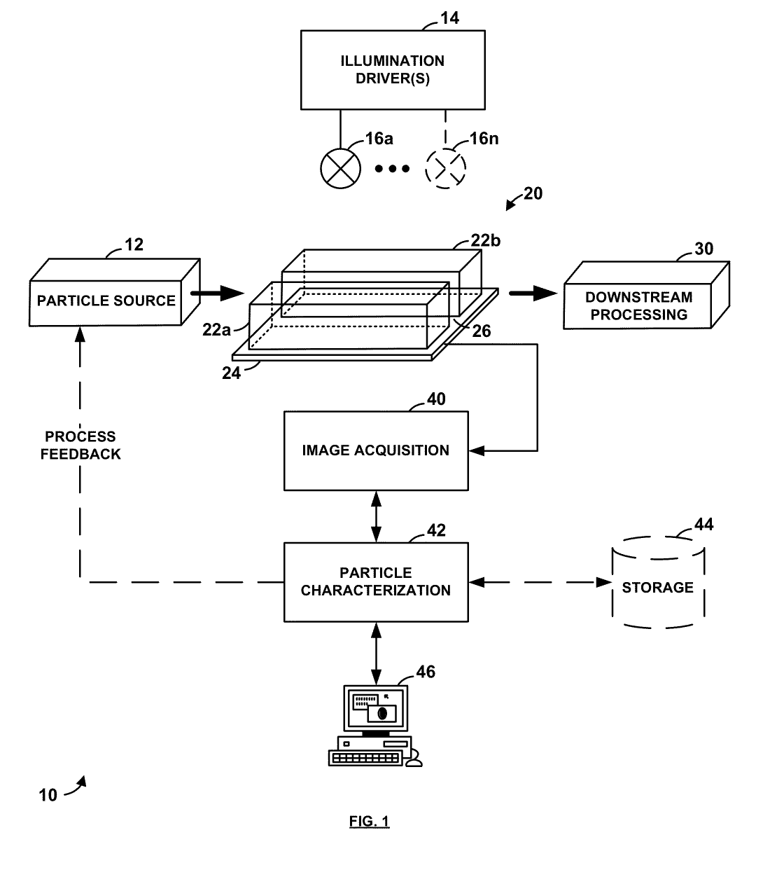

Referring to FIG. 1, a particle characterization system 10 according to the invention characterizes particles from a particle source 12, such as an industrial process. The process can perform a number of different types of operations on the particles, such as creating them, modifying them, and/or mixing them. In one example, the process is a dispersive process that disperses the active and inactive ingredients of a pharmaceutical agent.

The system also includes one or more illumination drivers 14 that drive one or more illumination sources 16a . . . 16n. These sources can be of a variety of different types and can exhibit a variety of different spectral characteristics. Some examples include visible wavelength illumination sources, narrowband coherent fluorescence excitation sources, or even simple ambient light sources. In a preferred embodiment, the illumination driver includes strobing circuitry that allows short illumination pulses to be produced.

The particle source provides particles that are suspended in a liquid that is passed through a microfluidic detection cell 20. The cell includes a hydraulic channel 26 that passes above or alongside a two-dimensional array detector 24, such as a CCD or CMOS array detector. This cell can be fabricated using a variety of different techniques, such as by machining a metal block or molding a plastic part to define a channel between a pair of walls 22a, 22b above the detector. The suspended particles can be conveyed through the microfluidic system in a variety of known ways, such as by pumping, gravity, or capillary action.

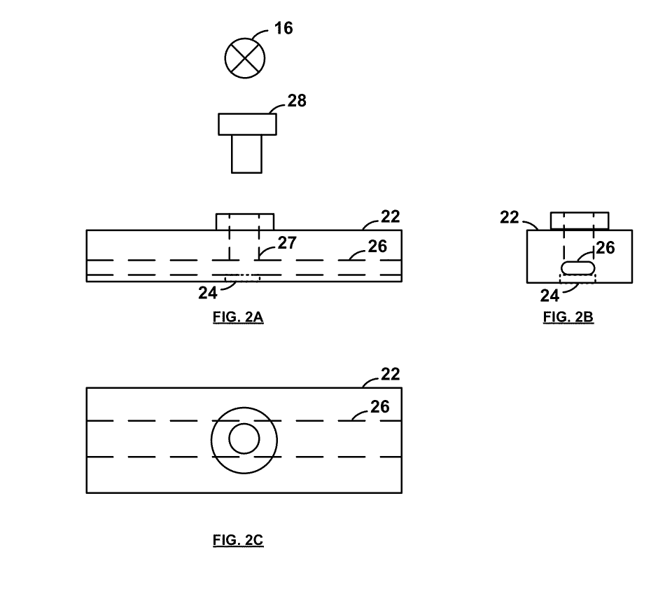

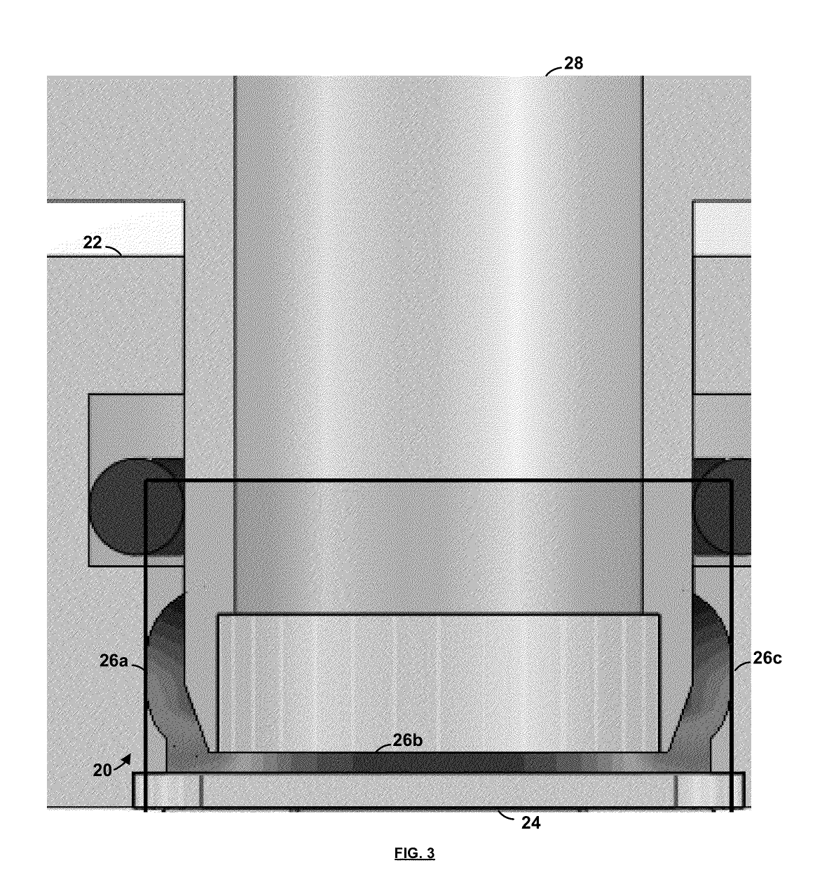

Referring to FIG. 2 in one embodiment, a cell channel block 22 can be machined in an aluminum block with a rectangular channel 26, with rounded corners, passing through its length just above its bottom. A recess in the bottom of the block holds a two-dimensional detector 24 below a window shaft 27. A window bolt 28 can then be slid into the window shaft such that it protrudes into the channel and thereby narrows it at a portion of the block. The window bolt has a transparent bottom through which light from a source 16 can shine into the narrow portion of the channel. In one embodiment, the height of the window bolt is adjustable.

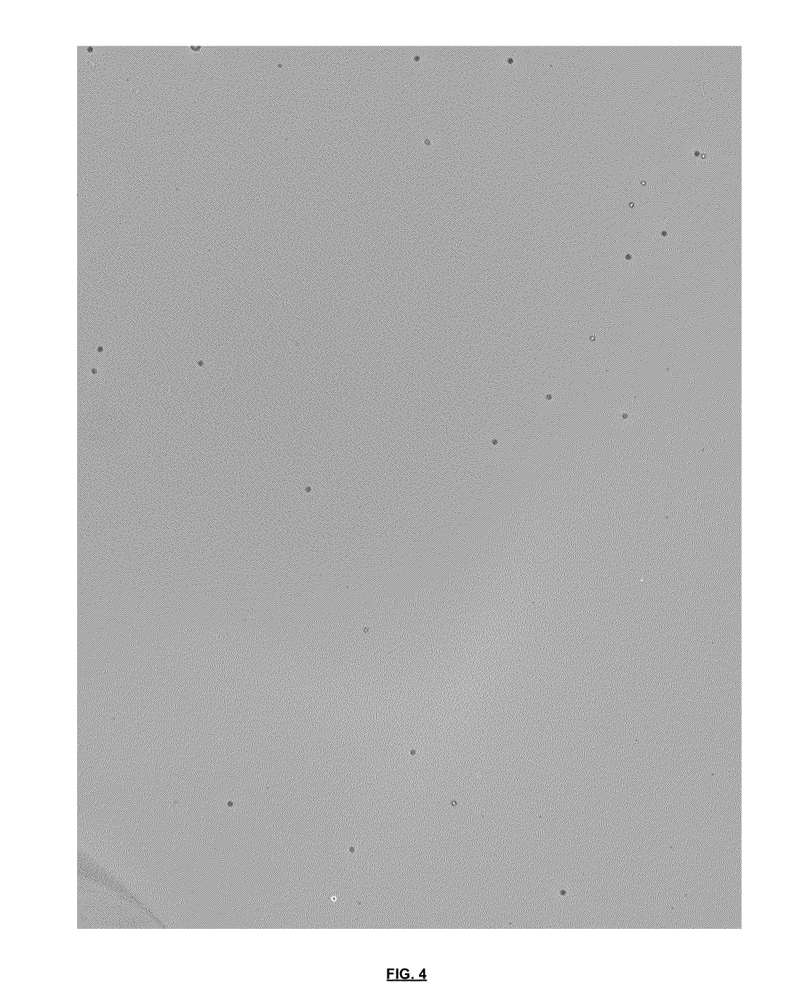

Referring to FIG. 3, the bolt creates an “eared” channel 26 that includes a first ear 26a on one side of the window bolt and a second ear 26c on the other side of the bolt. Between the two ears and below the bolt is an imaging region 26b. This region is between the lower transparent surface of the window bolt and the upper surface of the detector array 24.

This channel shape has been found to work well in the relatively high pressures that are found in some industrial processes, because it does not appear to cause aggregation or segregation, which can plague other geometries. This is believed to be at least in part because this channel shape does not appear to exhibit any zero-flow regions. The ears also provide an escape area for occasional large contaminant particles that might otherwise block the channel. Simulations have confirmed that, unlike with other geometries, different sizes of particles in a mixture will tend to flow evenly into the imaging area instead of becoming segregated, and that larger contaminant particles will generally make their into the ears instead of building up in front of the window bolt.

The cell channel block is glued to the array detector with an epoxy cement, although other methods of attachment are of course possible. It is contemplated that a larger channel block could be glued to more than one detector to allow for a larger single detection area or more than one detection area. These sets of detectors can help a system to acquire more data per unit time because large array detectors tend to take a long time to read. These sets of detectors can also provide apparent flow rates, which can be correlated with full flow rates. Detectors can be oriented at 90 degrees, as well, so as to provide different views of a same field of particles.

Referring again to FIG. 1, after passing through the microfluidic detection cell 20, the suspended particles move on to downstream processing, which can include further operations on the particles, further characterization of the particles, or both. In one embodiment, the suspended particles are provided to an off-the-shelf laser diffraction system for to further characterize them after the microfluidic detection. But the microfluidic detection can also take place after one or more other types of detection, or even in parallel with them. Detection systems that can provide information that is complementary to the microfluidic cell include any type of optical detection system that can operate on suspended particles, such as laser diffraction, Dynamic Light Scattering (DLS), or Static Light Scattering (SLS).

Laser diffraction is a well known technique for determining particle sizes. In this technique, light from a laser is shone into a suspension of particles. The particles scatter the light, with smaller particles scattering the light at larger angles than bigger particles. The scattered light can be measured by a series of photodetectors placed at different angles. This is known as the diffraction pattern for the sample. The diffraction pattern can be used to measure the size of the particles using light scattering theory that was developed in the early 20th century by Mie. As the instrument measures “clouds” of particles rather than individual ones, it is known as an “ensemble” technique.

DLS is also a well-known ensemble technique in which suspended particles scatter laser illumination. In this kind of technique, however, the time dependent fluctuation of the scattering is measured to understand Brownian motion in the sample. This provides information about the dynamic properties of particle systems, such as the hydrodynamic radius of the particles.

SLS statically measures scattered light intensity of light at different angles to obtain the molecular weight of suspended particles. Some instruments, such as the Zetasizer Nano, available from Malvern, Inc. of Malvern, UK, can perform both DLS and SLS measurements.

The combined approaches presented above can provide a level of insight into a particulate system that two separate measurements could not provide. Combining microfluidic detection with laser diffraction, for example, can allow a user to see images of particles before or after they pass through the laser diffraction system. While the laser diffraction system alone can provide precise size values, it is an ensemble technique that tends to favor high mass particles over smaller ones. With images coupled to these measurements, however, one can understand better what the laser diffraction measurement means.

In one embodiment, particles or groups of particles meeting one or more predetermined criteria can first be marked as preapproved using one upstream technique. Data from the application of one or more downstream techniques then need only be retained for particles that are preapproved. The preapproval can even gate the downstream technique so as to prevent any downstream acquisitions from taking place for non-preapproved particles.

An image acquisition subsystem acquires images from the two-dimensional array detector 24. This subsystem can be synchronized with the source in the case of strobed illumination, allowing for high-speed acquisition of particle images. With a suitable strobe sequence, the system can even acquire more than one image as it passes through the channel.

A particle characterization subsystem 42 can apply one of a number of different particle characterization functions to the particles, such as by categorizing them into defined morphological and/or color categories. Particles can also be counted and their occurrences can be statistically analyzed. Table 1 lists illustrative ways in which particles can be characterized.

TABLE 1

| | Example | |
|---|---|---|
| Parameter | value | Definition |
| ID | 516 | Unique ID of the particle - allocated in |
| | | the order that the particles are detected |
| Magnification | 2.50 | Magnification used to make the |
| | | measurement |
| CE diameter (μm) | 904.14 | The diameter of a circle with the |
| | | same area as the particle |
| Length (μm) | 1306.35 | All possible lines from one point |
| | | of the perimeter to another point |
| | | on the perimeter are projected on |
| | | the major axis (axis of minimum |
| | | rotational energy). The maximum |
| | | length of these projections is the |
| | | length of the object. |
| Width (μm) | 678.54 | All possible lines from one point |
| | | of the perimeter to another point |
| | | on the perimeter are projected on |
| | | the minor axis. The maximum length |
| | | of these projections is the width of |
| | | the object. |
| Max. Distance | 1318.07 | Largest distance between any two |
| (μm) | | pixels in particle |
| Perimeter (μm) | 3619.42 | Actual perimeter of particle |
| Major axis^{°} | 105.52 | Axis of minimum rotational energy |
| Area (μm²) | 371550.78 | Actual area of particle in sq. microns |
| Area (pixels) | 215018 | Number of pixels in particle |
| Circularity | 0.785 | Circumference of equivalent area circle |
| | | divided by the actual perimeter of the |
| | | particle = 2√ (πArea)/Perimeter |
| HS Circularity | 0.616 | High sensitivity circularity (circularity |
| | | squared) = 4 πArea/perimeter² |
| Convexity | 0.919 | Convex hull perimeter divided by actual |
| | | particle perimeter |
| Solidity | 0.905 | Actual particle area divided by convex |
| | | hull area |
| Aspect ratio | 0.519 | Width divided by length |
| Elongation | 0.461 | 1 - aspect ratio |
| Intensity mean | 61.310 | Average of all the greyscale values |
| | | of every pixel in the particle |
| Intensity standard | 29.841 | Standard deviation of all the greyscale |
| deviation | | values of every pixel in the particle |
| Center x position | 6898271.5 | x co-ordinate of center of mass of |
| (μm) | | particle |
| Center y position | 1797186.3 | y coordinate of center of mass of |
| (μm) | | particle |

Other characteristics can also be measured, and any of the measured characteristics and associated counts and/or statistical information can then be used in a variety of ways to evaluate the particles. For example, they can be compared with stored known-good criteria to evaluate whether the process is operating within a predetermined specification, they can be shown to the user on a workstation as images or in sortable thumbnail views, or they can be used to adjust the process.

The system can also calculate average grey scale values for the full field (average pixel brightness and pixel standard deviation) in order to provide a measure of homogeneity. A relatively steady average brightness and standard deviation suggests a relatively steady flow of particles. A change in brightness (or standard deviation) implies a change in particle flow. A few large particles in an otherwise steady flow of small particles, for example, should cause a lower average brightness (and average brightness & standard deviation is easy to plot). This simple calculation won't provide as much information as size/morphology calculations provide, but the calculation can be done without requiring any additional hardware.

Through the use of more than one source, the system can acquire different types of information about the suspended sample particles. For example, a first strobed acquisition can acquire successive visible-wavelength images of a particle in the channel. A second narrow-band source can then be turned on to detect any particles that fluoresce or to detect scattering patterns.

Systems according to the invention can be applied to a number of different types of processes, such as Metals, Mining, and Minerals (MMM) applications or the manufacture of pharmaceuticals, personal care products, foodstuffs, pigments, and biomaterials. An example of an application to a wet dispersion process is shown in FIG. 6. Although this figure shows the detection cell at the intake of a complementary detection system, the detection cell can also be positioned in a return conduit from the complementary detection system. In some embodiments, the two complementary detection processes can even take place in parallel or on separate branch lines from the process conduit.

### Example 1

A channel block as shown in connection with FIGS. 2-3 was glued to a 5-megapixel iPhone® camera chip with an epoxy cement. A suspension was made up of a mixture of 80 micron and 20 polystyrene microspheres with the four times as many of the smaller microspheres than the larger ones suspended in water. This suspension was pumped through the channel at a 2-liter-per-minute flow rate.

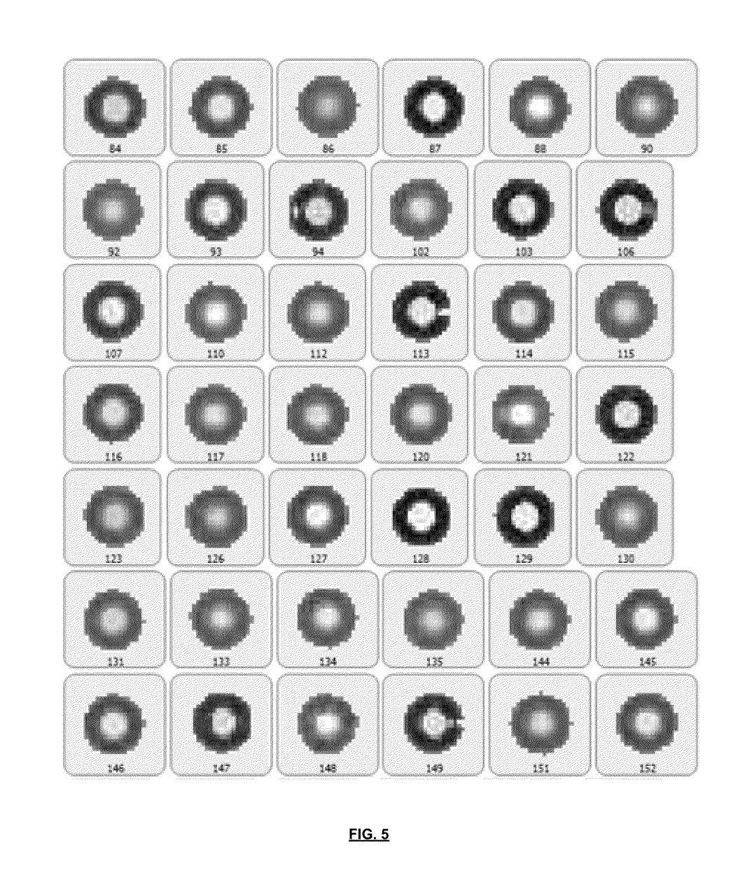

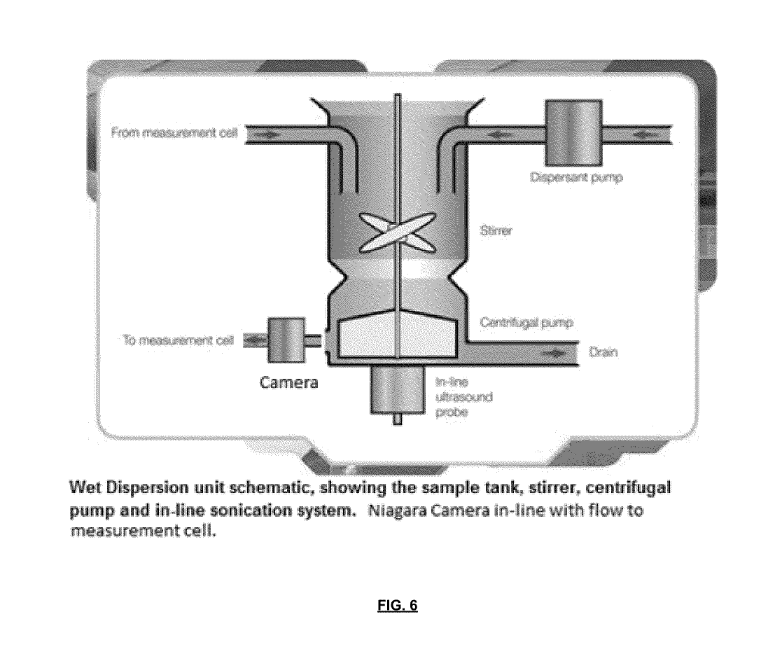

The suspension was illuminated with a strobed, white-light LED. Instead of using the chip's built-in shuttering capabilities, its sensor was left in acquisition mode and strobe pulses were used to define the acquisition period. The image shown in FIG. 4 was acquired, and the thumbnail set shown in FIG. 5 was assembled.

The suspension was also passed through a Mastersizer® laser diffraction system, available from Malvern instruments of Malvern UK. As predicted, the measurement from this system tended to favor the larger particles. But with the images from the microfluidic cell, this measurement can be corrected or put in the proper context.

The particle images can also be sorted according to their morphological characteristics as discussed in more detail in U.S. Pat. No. 8,111,395, which is herein incorporated by reference. Because the detector is capable of acquiring a huge amount of data, a local processor coupled to the detector can extract images of the particles themselves and only transfer these to a user computer for characterization. This can substantially reduce the amount of data transferred by eliminating transfers of white space.

Operations on the images as well as control operations, including control of the drivers, can be performed in connection with special-purpose software programs running on general-purpose computer platforms in which stored program instructions are executed on a processor, but they could also be implemented in whole or in part using special-purpose hardware. And while the system can be broken into the series of modules and steps shown for illustration purposes, one of ordinary skill in the art would recognize that it is also possible to combine them and/or split them differently to achieve a different breakdown.

### Flat-Field-Correction

The particle characterization system 10 can provide a software control that allows it to perform a flat-field correction in the presence of sample particles without purging or flushing. This flat field correction adjusts for imaging error sources, such as uneven illumination, surface reflections, defects (e.g., surface scratches), and non-uniform pixel response of the detector. Performing this type of correction on the fly without purging the instrument can significantly speed up operation and can simplify hookups by eliminating the need for a dedicated purge or flush path.

The on-the-fly flat-field correction can be performed in either of two ways. In the first approach, the system acquires a large number of frames and averages corresponding pixels in those frames. Since particles in each image are reasonably sparse, and will appear at random positions during each frame, the averaging will reduce the impact of any particles.

More specifically, the intensity of particle imprint is generally reduced to about 1/N, where N is the number of frames, so a higher number of frames improves the result. This approach has been tested for 2% obscuration with different numbers of frames from 10 to over 100 frames. Good results appear to require at least 50 frames, and particle contribution is very difficult to see in the 100-frame average. With a system that can acquire 7.5 frames per second, reasonable results could therefore be achieved in 15-30 seconds.

In the second approach, a smaller number of frames is averaged without including those parts of the image where particles are present. In this approach a threshold level is set that indicates the presence of a particle. By simply eliminating regions of a frame that are outside of that threshold on a per-frame basis, a small number of frames can be averaged to get a good background estimate. One simple way of doing this is to look at frame-to-frame differences—the presence of a particle in any causes a large difference (in the region obscured by the particle) from the prior frame. This approach would likely benefit from the inclusion of a measurement under known conditions (e.g., factory conditions). This method is outlined below:
Step 1: collect N consecutive frames
Step 2: for each pixel, calculate the mean and standard deviation σ across all N frames
Step 3: for each pixel, iterate through its values and reject values that differ from the mean by more than q*σ, where q is determined experimentally (typically, q=1)
Step 4: for each pixel, average the values remaining after outlier rejection.
The “frame” composed of averages represents the reconstructed background.

The outlier removal method can be performed on fewer frames (e.g., 10-20 frames), and the resulting background image is free from “traces” of particles that are visible in the averaging method. Part of the computation can be performed while acquiring data (summing pixel values and squared pixel values for the standard deviation). The process can also be made to be massively parallel, and thus lend itself to General-Purpose Computing On Graphics Processing Units (GPGPU) acceleration. The outlier removal method has the disadvantage of higher memory usage, because all collected frames remain in memory for the entire process, and it is computationally more expensive than the averaging method.

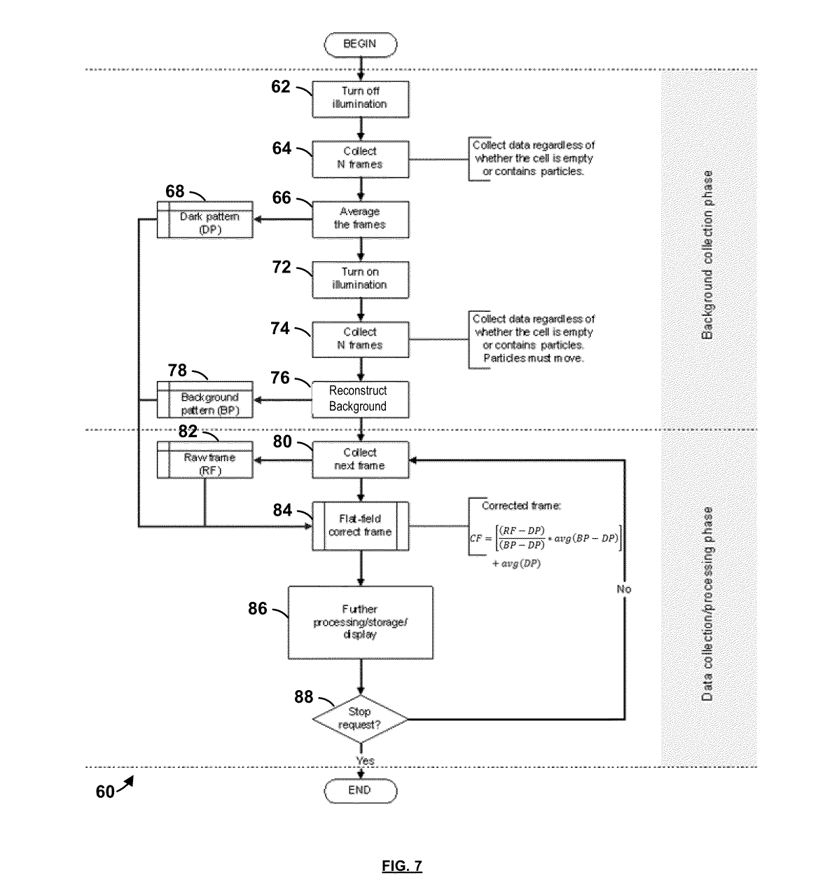

Referring to FIG. 7, the particle characterization system 10 begins a set of flat-field corrected acquisition operations 60 by turning off the illumination (step 62). It then acquires a number of frames, such as 100 frames (step 64), and averages them using one of the averaging approaches described above (step 66). The result is stored as a dark pattern data set (step 68).

The particle characterization system 10 then turns on the illumination (step 72). It then acquires a number of frames, such as 100 frames (step 74), and averages them using one of the averaging approaches described above (step 76). The result is stored as a background pattern data set (step 78).

The particle characterization system 10 can then acquire a sample image frame (step 80) and store it as raw frame data set (step 82). This raw frame data set (RF) is then corrected using the dark pattern data set (DP) and background pattern data set (BP). The correction can be calculated using the following formula:

$$CF = [ \frac{( RF - DP )}{( BP - DP )} * avg ( BP - DP ) ] + avg ( DP )$$

The corrected frame (CF) can then be stored, displayed, or otherwise processed (step 86). If further sample image frames are needed the process of acquisition and correction can be repeated (see step 88). It is possible to derive simpler flat-field correction solutions that may be more computationally efficient, although they may not behave as well as the exact solution above, particularly for non-uniform illumination.

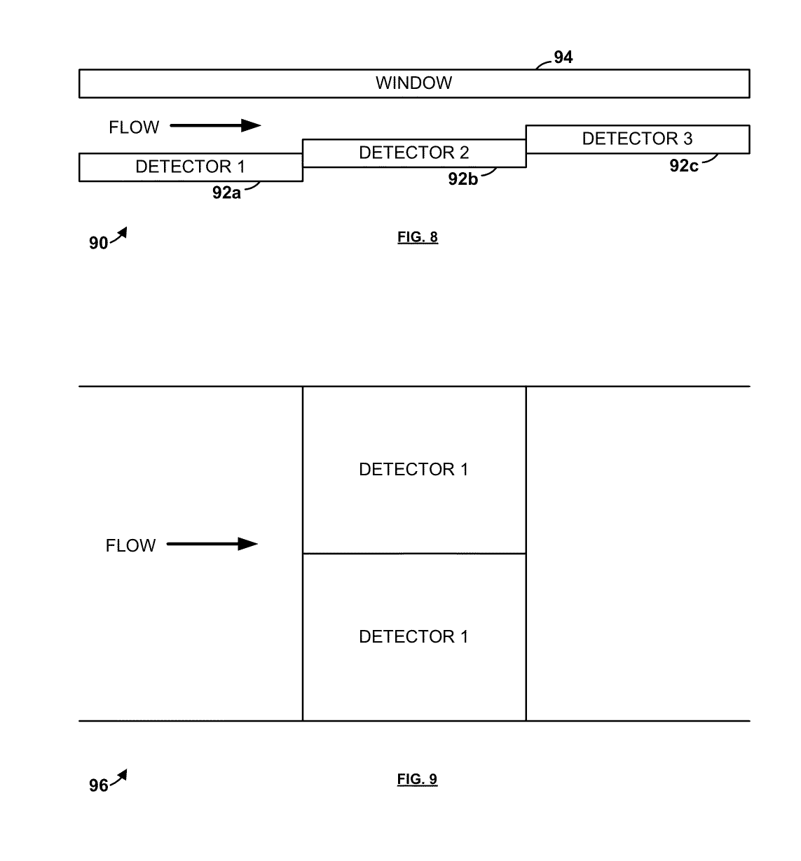

Referring to FIG. 8, particle characterization systems according to the invention can perform more than one type of measurement in a serial or parallel fashion. For example, a three-channel serial multichannel particle characterization system 90 includes three back-to-back detectors 92a . . . 92c positioned under a single illumination window 94. In operation, this system allows the first detector 92a to sample larger particles and subsequent detectors to sample smaller and smaller ones, with larger ones passing through the bypass channels. The results can be used separately or combined. As shown in FIG. 9, although serial configurations are presently contemplated as preferable, a parallel multichannel particle characterization system 96, in which the flow is divided across different side-by-side channels, can also be built.

Multichannel particle characterization systems can be built with any suitable number of detectors and it may also be possible to vary channel dimensions over the length of a single detector. These types of systems can also be built in a variety of ways. They can be built as a compound structure as illustrated in FIG. 8, for example, or they could be built with a series of microfluidic detection cells 20 (see FIGS. 1 and 2) connected in series with tubing. The systems can include one or more eared bypass channels for some or all of the detectors, depending on system requirements. Smaller-sample systems will tend to have lower bypass flows, for example, and larger re-circulating systems will have larger bypass flows.

The present invention has now been described in connection with a number of specific embodiments thereof. However, numerous modifications which are contemplated as falling within the scope of the present invention should now be apparent to those skilled in the art. For example, while the particles are described as being suspended in a liquid in the embodiments shown, they can also be suspended in a gas. Therefore, it is intended that the scope of the present invention be limited only by the scope of the claims appended hereto. In addition, the order of presentation of the claims should not be construed to limit the scope of any particular term in the claims.

What is claimed is:

1-34. (canceled)

35. A particle characterization method, comprising:
suspending particles in a fluid,
causing a first subset of the suspended particles to flow past a first two-dimensional array detector,
illuminating the first subset of suspended particles as they flow past the first two-dimensional array detector in the fluid,
acquiring a plurality of images of the first subset of particles as they flow past the first two-dimensional array detector in the fluid,
causing a second subset of the suspended particles to flow past a second two-dimensional array detector,
illuminating the second subset of suspended particles as they flow past the second two-dimensional array detector in the fluid, and
acquiring a plurality of images of the second subset of particles as they flow past the second two-dimensional array detector in the fluid.

36. The method of claim 35 wherein the step of causing a first subset of the suspended particles to flow past the first two-dimensional array detector and the step of causing a second subset of the suspended particles to flow past the second two-dimensional array detector are performed in series.

37. The method of claim 35 wherein the step of causing a first subset of the suspended particles to flow past the first two-dimensional array detector and the step of causing a second subset of the suspended particles to flow past the second two-dimensional array detector are performed in parallel.

38. The method of claim 35 further including the step of combining information from the images from the first and second two-dimensional array detectors.

39. The method of claim 35 wherein the step of causing a first subset of the suspended particles to flow past the first two-dimensional array detector and the step of causing a second subset of the suspended particles to flow past the second two-dimensional array detector together cause the average size of particles that flow over the second array to be larger than the average size of particles that flow over the first array.

40. The method of claim 39 wherein the step of causing a first subset of the suspended particles to flow past the first two-dimensional array detector causes the first subset of particles to flow through a first channel that has a first depth in front of the first detector, and the step of causing a second subset of the suspended particles to flow past the second two-dimensional array detector causes the second subset of particles to flow through a second channel that has a second depth in front of the second detector, and wherein the first depth is deeper than the second depth.

41. The method of claim 40 wherein the step of causing a first subset of the suspended particles to flow past the first two-dimensional array detector causes the first subset of particles to flow through a first compound channel that includes an imaging subchannel and one or more bypass subchannels that are larger than the imaging channel, and wherein the step of causing a second subset of the suspended particles to flow past the second two-dimensional array detector causes the second subset of particles to flow through a second compound channel that includes an imaging subchannel and one or more bypass subchannels that are larger than the imaging channel.

42. The method of claim 35 wherein the step of causing a first subset of the suspended particles to flow past the first two-dimensional array detector causes the first subset of particles to flow through a first compound channel that includes an imaging subchannel and one or more bypass subchannels that are larger than the imaging channel, and wherein the step of causing a second subset of the suspended particles to flow past the second two-dimensional array detector causes the second subset of particles to flow through a second compound channel that includes an imaging subchannel and one or more bypass subchannels that are larger than the imaging channel.

43. The method of claim 35 further including the step of causing one or more further subsets of the suspended particles to flow past one or more further two-dimensional array detectors,
illuminating the further subsets of suspended particles as they flow past the further two-dimensional array detectors in the fluid, and
acquiring a plurality of images of the further subsets of particles as they flow past the further two-dimensional array detectors in the fluid.

44. A particle characterization instrument, comprising:
a first two dimensional detector,
a second two-dimensional detector,
channel walls mounted to the first and second two-dimensional detectors for defining a first channel to hold a fluid containing a sample in contact with the first two-dimensional detector and defining a second channel to hold the fluid containing a sample in contact with the second two-dimensional detector, wherein the first channel and the second channel are hydraulically connected and have a different cross-section,
a driver to move the fluid through the channels, and
an imaging illumination source positioned to illuminate particles in the fluid while it is in contact with the two-dimensional detectors.

45. The apparatus of claim 44 wherein the channel walls define serial channels.

46. A particle characterization instrument, comprising:
means for causing a first subset of the suspended particles to flow past a first two-dimensional array detector,
means for illuminating the first subset of suspended particles as they flow past the first two-dimensional array detector in the fluid,
means for acquiring a plurality of images of the first subset of particles as they flow past the first two-dimensional array detector in the fluid,
means for using a second subset of the suspended particles to flow past a second two-dimensional array detector,
means for illuminating the second subset of suspended particles as they flow past the second two-dimensional array detector in the fluid, and
means for acquiring a plurality of images of the second subset of particles as they flow past the second two-dimensional array detector in the fluid.
